(19) United States
(12) Patent Application Publication
(10) Pub. No.: US 2020/0319481 A1
(43) Pub. Date: Oct. 8, 2020

(54) Eye Shielding Device

(71) Applicant: Robert Bright, Fayetteville, NC (US)

(72) Inventor: Robert Bright, Fayetteville, NC (US)

(21) Appl. No.: 16/372,478

(22) Filed: Apr. 2, 2019

(51) Int. Cl. G02C 7/16; G02C 11/00; G02C 9/00; G02C 11/08; G02C 5/00; G02C 7/10

(52) U.S. Cl. CPC G02C 7/16; G02C 11/12; G02C 7/102; G02C 11/08; G02C 5/001; G02C 9/00

(57) ABSTRACT

An eye shielding device for improving clarity in a moist environment includes a frame that is configured to position on a head of a user. A panel is coupled to the frame so that the panel is positioned over eyes of the user for shielding the eyes. The panel, which is substantially transparent, comprises an inner layer that is coupled to an outer layer so that the inner layer, the outer layer, and a perimeter of the panel define an interior space. A power module is coupled to the frame. A heating element is coupled to the panel and is positioned in the interior space. The heating element is selectively operationally couplable to the power module so that the power module is positioned to power the heating element to heat air that is in the interior space to drive moisture from exterior surfaces of the panel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to shielding devices and more particularly pertains to a new shielding device for improving clarity in a moist environment.

### BRIEF SUMMARY OF THE INVENTION

An embodiment of the disclosure meets the needs presented above by generally comprising a frame that is configured to position on a head of a user. A panel is coupled to the frame so that the panel is positioned over eyes of the user for shielding the eyes. The panel, which is substantially transparent, comprises an inner layer that is coupled to an outer layer so that the inner layer, the outer layer, and a perimeter of the panel define an interior space. A power module is coupled to the frame. A heating element is coupled to the panel and is positioned in the interior space. The heating element is selectively operationally couplable to the power module so that the power module is positioned to power the heating element to heat air that is in the interior space to drive moisture from exterior surfaces of the panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an eye shielding device according to an embodiment of the disclosure.

FIG. 2 is a front view of an embodiment of the disclosure.

FIG. 3 is a cross-sectional view of an embodiment of the disclosure.

FIG. 4 is a detail view of an embodiment of the disclosure.

FIG. 5 is an isometric perspective view of an embodiment of the disclosure.

### DETAILED DESCRIPTION OF THE INVENTION

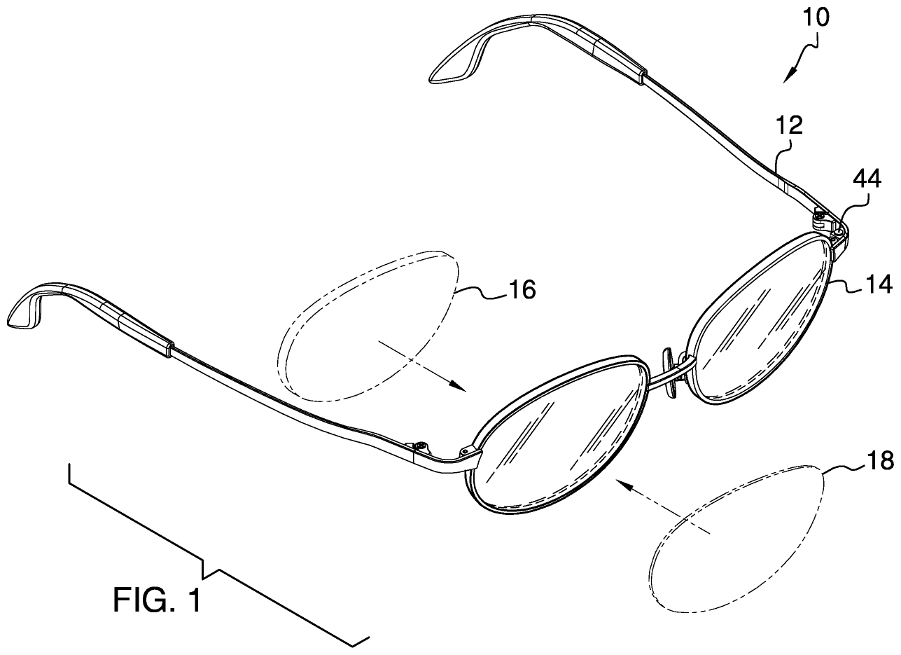

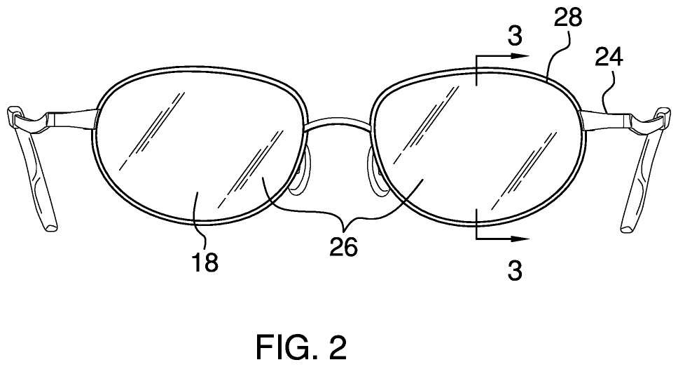

With reference now to the drawings, and in particular to FIGS. 1 through 5 thereof, a new shielding device embodying the principles and concepts of an embodiment of the disclosure and generally designated by the reference numeral 10 will be described.

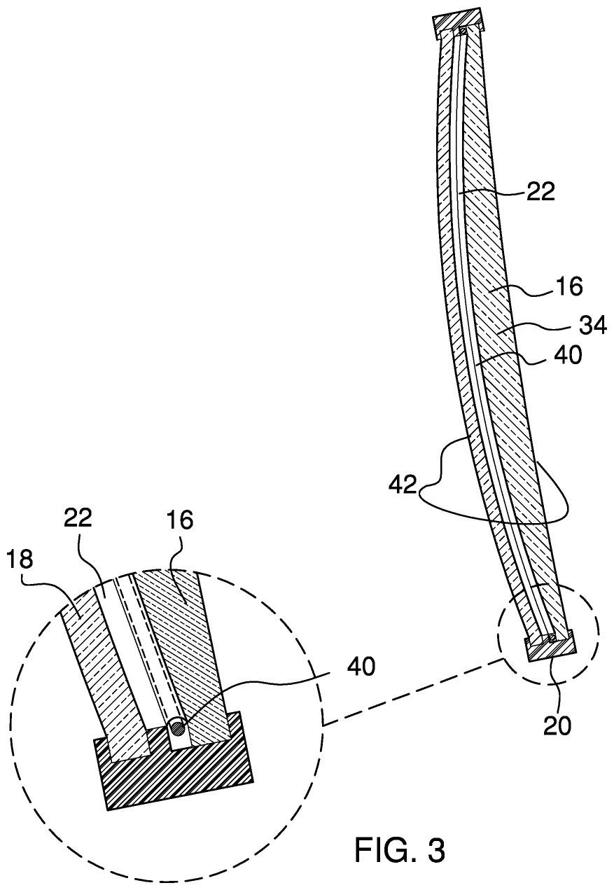

As best illustrated in FIGS. 1 through 5, the eye shielding device 10 generally comprises a frame 12 that is configured to position on a head of a user. A panel 14 is coupled to the frame 12 so that the panel 14 is positioned over eyes of the user for shielding the eyes. The panel 14, which is substantially transparent, comprises an inner layer 16 that is coupled to an outer layer 18 so that the inner layer 16, the outer layer 18, and a perimeter 20 of the panel 14 define an interior space 22, as shown in FIG. 3.

In one embodiment, as shown in FIGS. 1-4, the frame 12 is configured as an eyeglass frame 24 and the panel 14 is configured as a pair of lens modules 26. Each lens module 26 is coupled to a respective rim 28 of the eyeglass frame 24.

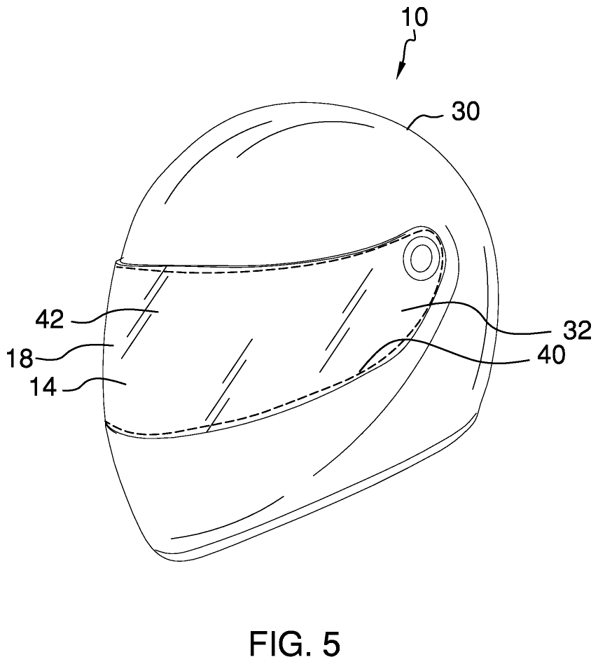

In another embodiment, as shown in FIG. 5, the frame 12 is configured as a helmet 30 and the panel 14 is configured as a visor 32. The helmet 30 is configured to position on the head of the user. The visor 32 is pivotally coupled to the helmet 30.

At least one of the inner layer 16 and the outer layer 18 comprise a corrective lens 34 so that the panel 14 is configured to correct a vision defect of the user. At least one of the inner layer 16 and the outer layer 18 comprise at least one of a silver halide, such as silver chloride, and an organic photochromic molecule, such as an oxazine or a naphthopyran, so that the panel 14 is configured to darken when exposed to sunlight to shade the eyes of the user.

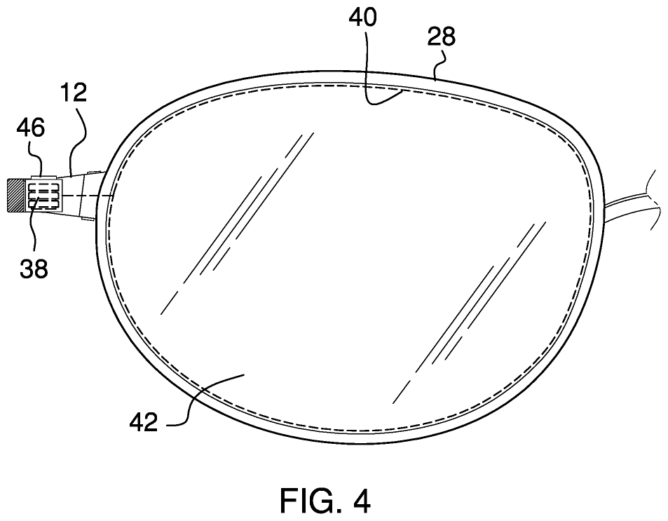

A power module 36, which comprises a battery 38, is coupled to the frame 12, as shown in FIG. 4. A heating element 40 is coupled to the panel 14 and is positioned in the interior space 22. The heating element 40 is selectively operationally couplable to the power module 36. The power module 36 is positioned to power the heating element 40 to heat air that is in the interior space 22 to drive moisture from exterior surfaces 42 of the panel 14. The heating element 40 is wire-type and extends around the perimeter 20 of the panel 14, as shown in FIG. 4.

A controller 44 that is coupled to the frame 12 is operationally coupled to the power module 36 and the heating element 40. The controller 44 is positioned to selectively couple the heating element 40 to the power module 36. The controller 44 comprises a button 46 that is depressible, as shown in FIG. 4. The button 46 is configured to be depressed a first time to operationally coupling the heating element 40 to the power module 36 and to be depressed a second time to decouple the heating element 40 from the power module 36.

In use, the user dons the frame 12, positioning the panel 14 over the eyes of the user. When the panel 14 is dampened with moisture, as can occur from rain or simply when moving from a cold space to a warm space, the user is positioned to actuate the heating element 40 using the button 46 to drive the moisture from the exterior surfaces 42 of the panel 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An eye shielding device comprising:
a frame configured for positioning on a head of a user;
a panel coupled to the frame such that the panel is positioned over eyes of the user for shielding the eyes, the panel being substantially transparent, the panel comprising an inner layer coupled to an outer layer such that the inner layer, the outer layer, and a perimeter of the panel define an interior space;
a power module coupled to the frame; and
a heating element coupled to the panel and positioned in the interior space, the heating element being selectively operationally couplable to the power module wherein the power module is positioned for powering the heating element for heating air in the interior space for driving moisture from exterior surfaces of the panel.

2. The device of claim 1, further comprising:
the frame being configured as an eyeglass frame; and
the panel being configured as a pair of lens modules, each lens module being coupled to a respective rim of the eyeglass frame.

3. The device of claim 1, further including at least one of the inner layer and the outer layer comprising a corrective lens wherein the panel is configured for correcting a vision defect of the user.

4. The device of claim 1, further including at least one of the inner layer and the outer layer comprising at least one of a silver halide and an organic photochromic molecule wherein the panel is configured for darkening when exposed to sunlight for shading the eyes of the user;

5. The device of claim 1, further including the power module comprising a battery.

6. The device of claim 1, further including the heating element being wire-type.

7. The device of claim 6, further including the heating element extending around the perimeter of the panel.

8. The device of claim 1, further including a controller coupled to the frame, the controller being operationally coupled to the power module and the heating element wherein the controller is positioned for selectively coupling the heating element to the power module.

9. The device of claim 8, further including the controller comprising a button, the button being depressible wherein the button is configured for depressing a first time for operationally coupling the heating element to the power module and for depressing a second time for decoupling the heating element from the power module.

10. The device of claim 1, further comprising:
the frame being configured as a helmet wherein the helmet is configured for positioning on the head of the user; and
the panel being configured as a visor.

11. The device of claim 10, further including the visor being pivotally coupled to the helmet.

12. An eye shielding device comprising:
a frame configured for positioning on a head of a user, the frame being configured as an eyeglass frame;
a panel coupled to the frame such that the panel is positioned over eyes of the user for shielding the eyes, the panel being substantially transparent, the panel comprising an inner layer coupled to an outer layer such that the inner layer, the outer layer, and a perimeter of the panel define an interior space, the panel being configured as a pair of lens modules, each lens module being coupled to a respective rim of the eyeglass frame, at least one of the inner layer and the outer layer comprising a corrective lens wherein the panel is configured for correcting a vision defect of the user, at least one of the inner layer and the outer layer comprising at least one of a silver halide and an organic photochromic molecule wherein the panel is configured for darkening when exposed to sunlight for shading the eyes of the user;
a power module coupled to the frame, the power module comprising a battery;
a heating element coupled to the panel and positioned in the interior space, the heating element being selectively operationally couplable to the power module wherein the power module is positioned for powering the heating element for heating air in the interior space for driving moisture from exterior surfaces of the panel, the heating element being wire-type, the heating element extending around the perimeter of the panel; and
a controller coupled to the frame, the controller being operationally coupled to the power module and the heating element wherein the controller is positioned for selectively coupling the heating element to the power module, the controller comprising a button, the button being depressible wherein the button is configured for depressing a first time for operationally coupling the heating element to the power module and for depressing a second time for decoupling the heating element from the power module.

13. The device of claim 12, further comprising:
the frame being configured as a helmet wherein the helmet is configured for positioning on the head of the user; and
the panel being configured as a visor, the visor being pivotally coupled to the helmet.
